(19) United States
(12) Patent Application Publication
(10) Pub. No.: US 2006/0117542 A1
(43) Pub. Date: Jun. 8, 2006

(54) Method for shaping a work piece and shaping device

(75) Inventors: Stelios Katsibardis, Coburg (DE); Kai Spath, Coburg (DE)

Correspondence Address: SCHWEGMAN, LUNDBERG, WOESSNER & KLUTH, 121 S. 8TH STREET, SUITE 1600, MINNEAPOLIS, MN, 55402, US

(73) Assignee: Langenstein & Schemann GmbH

(21) Appl. No.: 11/335,109

(22) Filed: Jan. 19, 2006

Related U.S. Application Data
(63) Continuation of application No. PCT/EP04/06502, filed on Jun. 17, 2004.

(30) Foreign Application Priority Data
Jul. 19, 2003 (DE) DE 103 32 888.2

(51) Int. Cl. B23Q 17/00

(52) U.S. Cl. 29/407.05; 29/407.01; 29/709

(57) ABSTRACT

The invention relates to a method for shaping a workpiece and to a shaping device. The shaping device comprises at least one support (3) for a workpiece (4), at least one striking tool, at least one drive device (2) and at least one position sensing device for determining the position of the striking tool. For shaping the workpiece (4), an initial position of the striking tool can be adjusted. A control and regulation device controls and regulates the speed of the striking tool during a striking motion. According to the method of the invention, the striking tool, during a striking motion from a defined initial position, impacts the workpiece (4) present on the support (3) with an impact speed. The speed of the striking tool during the striking motion is controlled or regulated subject to the position of the striking tool and subject to the defined impact speed.

### RELATED APPLICATIONS

This application is a continuation under 35 U.S.C. 111(a) of PCT/EP2004/006502, filed on Jun. 17, 2004, and published on Mar. 3, 2005 as WO 2005/018850A1, which claims the benefit under 35 U.S.C. 119 of German Application No. DE 103 32 888.2, filed Jul. 19, 2003, which applications and publication are incorporated herein by reference.

### DESCRIPTION

The invention relates to a method for the shaping of a workpiece as well as a shaping device, particularly for its use in the method or for the execution of the method.

Numerous methods and devices are available for the shaping of workpieces. The workpieces are brought into contact with suitable tools in pressing machines which provide the power necessary for the process. The pressing machines differ from each other by virtue of and working bound pressing machines generally. In connection with this, of special interest are the working bound shaping devices or pressing machines, particularly the spindle press. The defining characteristic of the work-bound pressing machines is the work capacity E, which is converted completely at every operation.

In a spindle press, the spindles are driven by a form- or friction-bound flywheel or also by direct motor drive. The rotation is converted about a steep common multiple thread in a straight pestle movement. When the striking the workpiece with the pestle, the kinetic energy from the flywheel, spindle and pestle is converted completely into useful and lost work. The conversion of energy is indicated by the striking effectiveness, ηs. (Lexikon Produktionstechnik Verfahrenstechnik, Hrsg. Heinz M. Hiersig, VDI-Verlag).

As a rule, the drive for the spindle, e.g., the flywheel is set in motion with an electrical drive motor, preferably an asynchronous motor. In order to achieve optimal operating response, i.e. drive performance, current consumption, degree of effectiveness, flexible ranges of application, and short piston stroke times, it is desirable to correspondingly control and to regulate the spindle press, e.g., the pestle piston stroke.

In the printed publication DE 34 44 240 C2 a spindle press is disclosed, with which the rotational speed with a pestle is widely adjustable and also shaping work therefore can be carried out with a relatively low work capacity like e.g. edge upsetting. The spindle press contains a flywheel connected to a drive, which shows an initial speed at the beginning of the pestle stroke, which is connected to the spindle over a disc clutch with the driving pulley and which approximately comes to a standstill and is disconnected from the spindle at the end of the shaping process. The spindle with the spindle driving pulley also has a drive of its own which at the same time also serves for the return stroke of the pestle. For the working stroke, the spindle is accelerated by way of the spindle drive, preferably maximally, and then regulated downwardly for the speed required for the clutch with the flywheel at the end of the empty piston stroke.

If the largest portion of the pestle piston stroke will have obtained a higher speed with a split clutch as disclosed in DE 34 44 240 for the spindle press for itself, the process is achieved by short stroke times. In any event, it is necessary to have two high-performance drive motors with this form of carrying out the process, which can lead to a high current demand. If the speeds are not regulated with exactness, energy can be lost by the clutch process.

Printed publication DE 38 41 852 A1 describes a drive layout for driving a threaded spindle of a spindle press, that is accomplished with the coupling of a threaded spindle to a driving pulley permanently rotating about a differential with respect to an overlapping transmission. For the interlink, movement of the transmission is braked. By corresponding control and regulation of the deceleration, speed and torque and therewith the pressing strength and piston stroke speed can be varied during the cycle. Moreover, the braking energy can be released, for example and used for the return stroke of the pestle.

It is the disadvantage of this construction that a permanently rotating driving pulley is necessary, which leads to a higher energy consumption. A further disadvantage is the large speed difference between spindle and driving pulley at the coupling, which results in energy consumption and clutch wear.

A directly driven spindle press is disclosed in DE 195 45 004 A1. Here, an optimal operating response is reached by it for the improvement in the energy balance and for a more exact regulation of the way-time path a variable-speed drive is used consisting of a three-phase current asynchronous motor and a frequency setting or transformer. The required shaping energy is adapted by variation of the speed. The velocity-time path of the spindle can be varied by facilities for the control or regulation of the drive.

By variation of the velocity-time path, relatively short piston stroke times can be realized for reaching the respectively desired shaping energy. Tolerances caused by the mechanics remain though, for example at the return piston stroke of the pestle or unconsidered tolerances in the workpieces, which on the one hand, have an effect on the precision of the shaping process and on the other hand can lead to an energy loss also.

Another directly driven spindle press is depicted on the internet page: Lasco-Fimrenzeitschrift “upgrade” (Edition: December 2000). As an example a shaping procedure is shown with lesser shaping energy. The drive engine with frequency converter accelerates the movable structures, that is flywheel and spindle coupled therewith, corresponding to the maximum energy of a corresponding rotational speed. The pestle is driven downwards with maximum speed until shortly before the beginning of the shaping process, and then slowed with the pre-selected speed to begin the shaping process. The reverse stroke is made by reversing the drive. Approximately halfway during the reverse stroke, braking reoccurs and the drive elements are so delayed such that the mechanical brake works as a park brake merely in the upper dead-motion point.

Relatively short piston stroke times can be realized as in the case of the spindle press revealed in DE 195 45 004 A1 for reaching the respectively desired shaping energy in this previously described spindle press. Tolerances caused by the mechanics remain, though, the speed of the pestle or the speed of the drive motor and the position of the pestle in which they are braked without consideration, there are also firmly predefined for example at the moving piston stroke of the pestle or tolerances in the workpieces depending on workpiece.

It is therefore the task of the invention to provide a method for shaping a workpiece as well as a shaping device particularly for the use in the method or for the execution of the method at which the aforementioned disadvantages are partly overcome or reduced at least at least at the level of technology.

This task is solved with regard to the method to shaping a workpiece with the features of the patent claim 1 and with regard to the shaping device with the features of the patent claim 28.

With the method in accordance with claim 1 of shaping at least one workpiece, a striking tool impacts a workpiece disposed upon a carrier during a striking movement from a pre-selected initial position and with a pre-selected impact velocity, and the velocity of the striking tool during the striking movement is controlled and regulated by the position of the striking tool and also dependent upon the pre-selected impact velocity.

The shaping device in accordance with claim 28, particularly to the application of the process or for the completion of the process in accordance with claim 1, or in accordance with one of the claims dependent from claim 1, comprises at least a support for a workpiece, at least a striking tool, at least a drive facility for moving the striking tool relative to the support, and at least a position sensor for determining the position of the striking tool. Thereby, the shaping of the workpiece is dependent upon an initial position of the striking tool, which is or can be pre-set, and thereby, a control and regulation device is provided, which so controls and regulates the velocity of the striking tool during a striking movement in connection with the initial position, that a selected or pre-selected striking velocity is achieved upon the workpiece.

The striking movement is the preferably axial movement of the striking tool (or: pestle) in the direction of the workpiece and to be more precise from an initial position out until the collision with the workpiece. The height difference which the striking tool passes through during the striking movement of the initial position until the impact on the workpiece is the piston stroke of the striking tool, marked by working stroke or striking piston stroke in the following also. As a rule, the striking tool is driven back into a pre-selected stop position before the shaping procedure. The height difference that the striking tool moves through during the backward movement is also referred to as the return stroke.

The speed of the striking tool during the striking movement is a measure for the available movement energy (E). The movement energy is proportional to the product from the mass (m) of the striking tool and the square of the speed (V) of the striking tool (E=½ mv²). Since the mass of the striking tool is constant during the striking movement, so the speed of the striking tool or the initial position or the working stroke play primarily the acceleration (dynamic equations) of the striking tool, a decisive role for the movement energy at the impact available. The movement energy at the impact which results from the impact velocity of the striking tool also is described below as a shaping energy.

Upon the impact, the shaping energy on the workpiece is mostly transformed to useful work, by which the workpiece is deformed. Among other things the lost energy or the resulting lost work is captured in the recoil of the striking tool.

It is therefore a central thought of the invention that the speed of the striking tool can be controlled or regulated by the position of the striking tool depending during the striking movement to reach a desired or predefined impact velocity. This means in other words, that the short-term speed (V(t)) of the striking tool is a function of the short-term position (x(t)) of the striking tool (V(t)=V(x(t)). Therefore, the position (x) of the striking tool is the variable here. The impact velocity of the striking tool is a constant which can, however, be chosen arbitrarily to its value. The striking tool therefore is either accelerated or braked, depending on in which position (or: position) it finds itself, in order to reach the predefined impact velocity in any event.

The initial position (x(t₀)) of the striking tool can depending be determined and adjusted by the requirements of the workflow depending on the predefined impact velocity, or what, for example if the striking movement shall be carried out with a constant speed or a constant acceleration.

Therefore, the method in accordance with the invention has the advantage that a desired impact velocity and the resulting shaping energy parameter provided by the physical qualities can be reaching independently from the adjusted initial position, and that a desired initial position can be adjusted similarly within certain limits independent impact speed provided by it. Thereby, the shaping process is very flexibly usable.

A position of the striking tool can be measured or determined around the speed during the striking movement as a function of the position of the striking tool to investigate in an advantageous execution form at least. The velocity values then can be ascribed to the position of the striking tool and the predefined impact velocity during the striking movement.

The position of the striking tool is preferably determined with a suitable positional value and a suitable positional directional measurement for the control or regulation of the striking tool. On the one hand, through this it is to determine a certain position, for example the initial position, possibly and then this one to charge the necessary impact velocity, or for predefinedly reaching the most favorable or optimal speed and direction. The striking tool is then controlled or regulated during the striking movement toward this velocity. On the other hand, a control or regulation also can be made in real time by always being measured short-term or by being determined during the striking movement and then being correspondingly controlled or regulated short-term based upon position preferably by numerical differencing.

That the position of the striking tool is known in accordance with the invention within the shaping device any time, has the broader advantage that an exact work-repeating process is made possible. It is advisable particularly if for example by the position measuring capability, the initial position of the striking tool and/or the position is measured or decided after a return stroke movement of the striking tool. A too big tolerance should, for example, so that tool hits impact velocity the workpiece open provided the exact with in turn appear at the return stroke movement of the striking tool now, i.e. the striking the actual moving piston stroke is greater or lesser than the predefined height difference, this gets so included by the position measuring facilities and used for the determination of the speed course of a following working stroke.

With multiple impacts of the striking tool upon the same workpiece, it is advantageous for the position of the striking tool to be determined after the impact and deformation of the workpiece. Thereby, the height changed by the deformation of the workpiece can be included and subsequent working strokes can be by way of example, extended such that during repeated processing of the workpiece within the shaping device, that the shaping energy transferred to the workpiece is always constant.

In a particularly advantageous execution embodiment, the striking tool is accelerated from the initial position on the predefined impact velocity. It can be advantageous to achieve an impact velocity that is less than a maximum impact velocity if the initial position is adjusted to be lower than a maximum initial position.

As a rule, the striking tool can pass at its striking movement through a maximum working stroke provided by the shaping device from a maximum initial position after which the largest or maximum impact velocity and with that the maximum shaping energy is reached. Due to the ability to determine the position of the striking tool, however, the pestle or the striking tool also can be driven from any arbitrary position within the maximum working stroke so that a working stroke results in a lesser working stroke than the maximum working. The highest attainable impact velocity or shaping energy is then lower than the maximum impact velocity or shaping energy.

This is a particular advantage in the application of shaping energy with flat workpieces and/or a lower amount of shaping energy is needed. When accelerating from the initial position, the desired impact velocity or shaping energy is then just reached at the impact on the workpiece. The short working stroke has on the one hand entailed for very short piston stroke times by what can be obtained for very short time times, on the other hand energy can be saved through this also.

It also can particularly advantageously be reached around the predefined impact velocity, if the striking tool is accelerated from the initial position and braked when achieving a pre-selected position between the initial position and the workpiece. So the speed is varied about the piston stroke length so that producing low impact velocities or possible for shaping energy also is from a high initial position and at a great working stroke, for example. Nevertheless, in order to reach a short stroke time, the striking tool is first maximally accelerated from resting to a maximal velocity, which is reached from the previously determined position between the starting position and the workpiece, such that the desired impact velocity is braked, which is lesser than the maximum velocity.

A very high initial position can therefore be chosen in practice when working on the top of very big or long workpieces to make easier feeding the workpiece onto the support, for example. Also automatic feeding of the workpieces, for example robots with grabs or automatic gripping tools, can be a high initial position of the striking tool of advantage to make the supplying easier. From this high initial position can then both high and low shaping energy be produced when proceeding in accordance with the invention depending on a specific application.

Furthermore it is particularly advisable if the speed of the striking tool is controlled or regulated during the striking movement so that at an arbitrary initial position this one is reached possible working stroke time most briefly. This can be realized the control and regulation facilities which depending on the position and the predefined impact velocity of the striking tool arithmetically optimize the velocity path of the striking tool so that the shortest piston stroke time is reached if possible.

The control and regulation of the speed of the striking tool is preferably carried out with control and regulation facilities which control and regulate a speed variable drive engine of drive facilities for the striking tool.

A frequency converter unit is preferably used as control and regulation facilities, by which the velocity and the direction of rotation of the drive engine is controlled and regulated. It is particularly advantageously if the frequency converter unit with the help of a microprocessor determines position, the velocity path of the drive engine during the striking movement, with is dependent of a predefined impact velocity and a predefined initial position and/or one by a position measuring facility.

In a particularly advantageous execution embodiment of the method in accordance with the invention, the striking tool is raised back after the impact by a return stroke movement into a predefined stop position. The return stroke movement into the stop position is carried out preferably at a reversed direction of rotation of the drive engine. However also other methods are conceivable to bring the striking tool into the stop position. For example, the striking tool can get back elevated hydraulically or pneumatically by means of telescope bars. The pressure necessary for the striking movement of the pestle can be achieved by pressuring a liquid or a gas in a suitable pressure chamber.

It particularly advantageous if the speed of the striking tool is steered and regulated by the position of the striking tool depending during the return stroke movement toward the stop position. The striking tool is given an optimal control and regulation of the speed by the frequency converter unit whose microprocessor determines the speed course during the piston stroke into dependence of the predefined stop position and/or a position determined by means of the position measuring facilities. This control and regulation possibility can be used at the return stroke of the striking tool by means of the drive engine.

It is particularly useful if as a stop position of a moving piston stroke, the initial position of the striking tool is chosen for the working stroke. Primarily if more workpieces shaped in sequence, the optimal piston stroke time and shaping energy can be reached. It is possible, however, to drive the striking tool to an arbitrarily different stop position. This can be of advantage if after each other workpieces shall be processed differently. The stop position of the moving piston stroke then can depending particularly be chosen by the workpiece to be worked on and/or by the desired impact velocity at the following striking movement.

In a particularly advantageous execution embodiment, the striking tool is on the one hand accelerated away from the workpiece or support into the stop position, and when achieving a pre-selected position between the workpiece and the support at the return stroke movement and braked at the stop position on the other hand by the drive engine. When reaching the stop position, the striking tool then is braked completely by mechanical braking facilities. These control and regulation of the speed in the return stroke movement has the advantage that the striking tool can be driven to the stop position very exactly, simultaneously, reaches this stop position very fast, however. Furthermore the danger is reduced that the mechanical braking facilities wear out fast or that the overflow or the tolerance of the moving piston stroke is too big as it can be the case at too high speed of the striking tool when reaching the stop position.

This exact speed regulation in the moving piston stroke or the exact stop position resulting from it of the striking tool is for example particularly advisable if the workpiece is removed when the striking tool is driven to the stop position and the stop position is also with the striking tool up. The workpiece then can always be removed and placed aside with high precision with the help of an removing device, for example a gripping tool.

In a particularly useful execution embodiment, the striking tool is accelerated when accelerating with a predefined constant initial acceleration. The striking tool preferably is braked also when braking with a predefined constant braking acceleration. Thereby, a high precision and an energy-saving mode of operation is simultaneously achieved. The amount of the constant initial acceleration and the constant braking acceleration can respectively be chosen depending on the direction of motion of the striking tool therefore depending on whether it carries out a striking movement or a return stroke movement, for example. The effect of the gravity on the striking tool, for example, can be taken into account and then the acceleration can be selected correspondingly.

It is particularly advantageous if the drive motor is switched off or disengaged within the shaping device just before the impact of the striking tool upon the workpiece. Through this method, loads for the engine and the control and regulation facilities which can be caused by appearing current and voltage peaks are avoided. The drive engine allows itself to be switched instantly by the frequency converter unity. The instant switching or disengagement is carried out on a signal of the position measuring facilities shortly before the impact, for example, so that no shaping energy is lost if possible.

In a particularly advantageous execution of the method in accordance with the invention, the drive engine as a generator is operated during braking the striking tool by means of the drive engine. The energy recovered by the generator during the braking action then can be economized back into the power supply system. The position of the striking tool in the shaping device is preferably determined by at least one, particularly contact less position determiner, particularly one visual or magnetic or inductive and preferably by an incremental position determiner. It is the advantage of this method that the measuring can be carried out without contacts and the measuring facilities can therefore be attached to a fixed position in the machine.

In an advantageous execution embodiment of the method in accordance with the invention, a shaping device which is executed as a spindle press is used and the drive engine works in the drive implementation of the spindle press. The drive engine is preferably directly driven by a flywheel, which in turn puts a spindle coupled therewith into rotation. The spindle acts in combination with the striking tool preferably about a thread that this is moved depending by the direction of rotation to or of these away to the workpiece or support by the rotation of the spindle.

Particularly for employment of the method or completion of the method in accordance with the previously set forth inventive concept of a shaping device, the method comprises at least a support for the workpiece, at least a striking tool, at least a drive device for moving the striking tool relative to the support, and at least a position-measuring device for determining the position of the striking tool within the shaping device, whereby shaping the workpiece is done by setting an initial position of the striking tool within the shaping device, and whereby a control and regulation device is contemplated, which controls the velocity of the striking tool dependant upon its position, and which is regulated to achieve a selected or pre-selected impact velocity.

The shaping device is preferably a spindle press. However, it is also conceivable to adapt the shaping device as another power-operated shaping machine or pressing machine, for example a hammer, or pressing machines as one like a hydraulic press. The shaping devices are essentially then different in the concrete arranging of the driving facility. Letting a variety of possible drives steer and regulate itself with suitable means so that the speed can be varied about the piston stroke. By the use of the position measuring facilities this is then possible out of any arbitrary initial position, too.

If the shaping device is therefore executed at the execution of the method according to the invention as a spindle press, then the drive facilities contain preferably a speed variable drive engine in which particularly an asynchronous machine can be used. Furthermore the drive facilities contain a flywheel that is coupled with a spindle and is driven by the drive engine.

In a particularly advantageous execution form of the shaping device, a frequency converter unit which the drive motor speed and perhaps also the direction of rotation of the drive engine steers and regulates is carried out by control and regulation facilities. The frequency converter unit preferably contains a microprocessor. Among other things the desired values can be entered for the respective initial position and the speed into a memory affiliated to the microprocessor. The values included by the position measuring facilities are also transmitted as a signal to the microprocessor. From these values, the processor then determines or calculates necessary or most favorable speed course during a striking movement.

For the return stroke movement of the striking tool of the workpiece or support, a stop position is preferably for the striking tool adjustable or adjusted, moreover. The stop position also gets one stored in the memory affiliated to the microprocessor so that the processor also can calculate the course of the return stroke movement. The return stroke movement is carried out preferably over changing the direction of rotation of the drive engine.

It is particularly advantageous if mechanical braking facilities are provided at the stop position of the striking tool. The mechanical braking facilities or brake then has an effect on the flywheel when reaching the stop position, for example, the flywheel is held fast and thereby the striking tool is also stopped in its movement.

The position measuring facilities preferably comprise a conventional and particularly contactless position determiner, and preferably an incremental position determiner particularly a visual, magnetic, or inductive position determiner.

The invention is further explained in the following with execution examples and under reference to the enclosed drawings.

The respective representations depict:

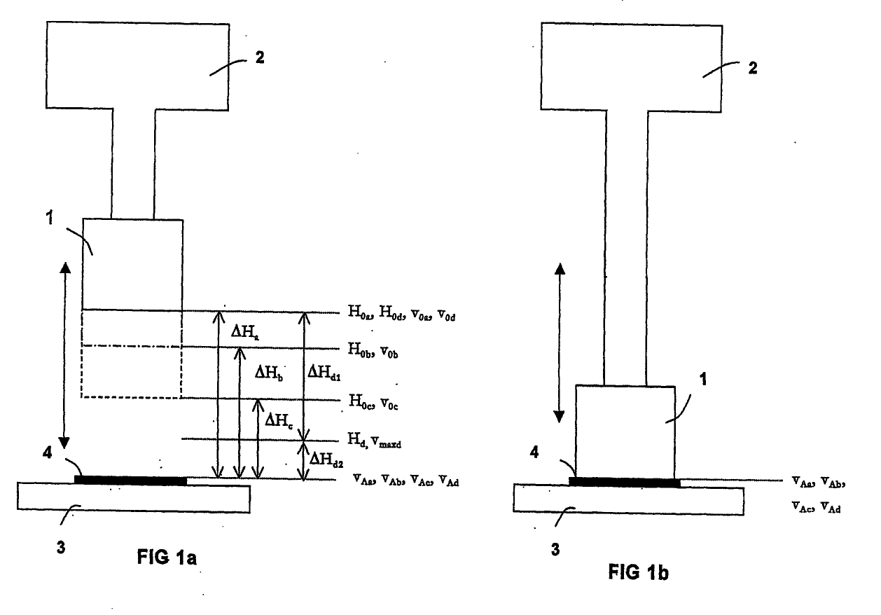

FIG. 1a a simplified representation of an embodiment of carrying out the method in accordance with the invention;

FIG. 1b the method in accordance with FIG. 1a after a completed striking movement;

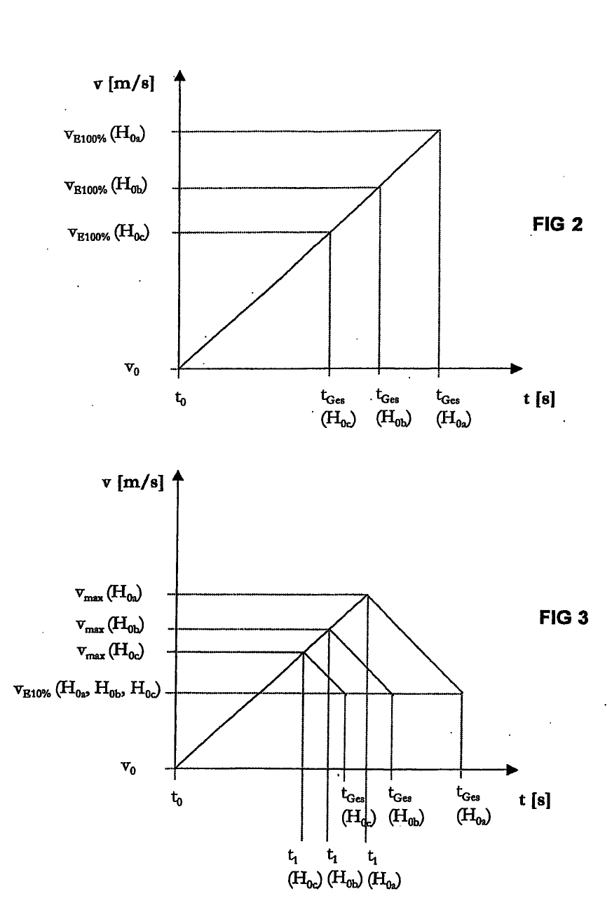

FIG. 2 illustrates a velocity-time diagram, which depicts theoretical velocity-time paths at constant initial acceleration;

FIG. 3 a velocity-time diagram, which depicts theoretical velocity-time paths at constant initial acceleration and following constant deceleration for a constant impact velocity from different initial positions;

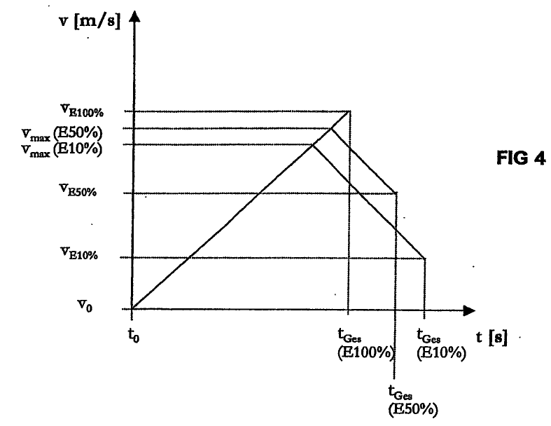

FIG. 4 a velocity-time diagram, which depicts theoretical velocity-time paths for reaching different impact velocities from a constant initial position;

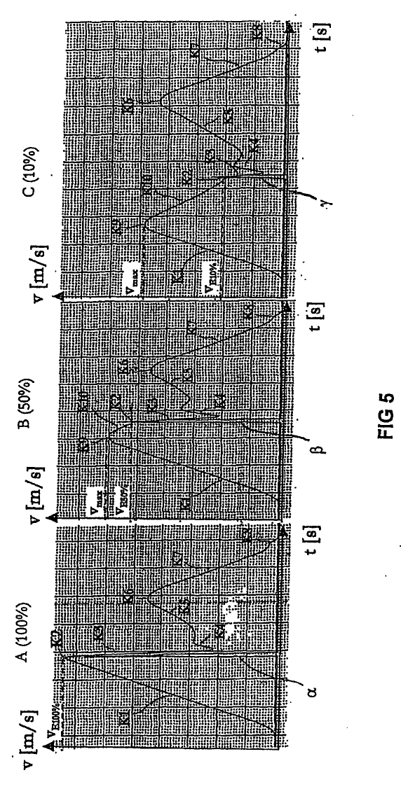

FIG. 5 a velocity-time diagram, which depicts real, measured velocity-time paths of the method in accordance with the invention;

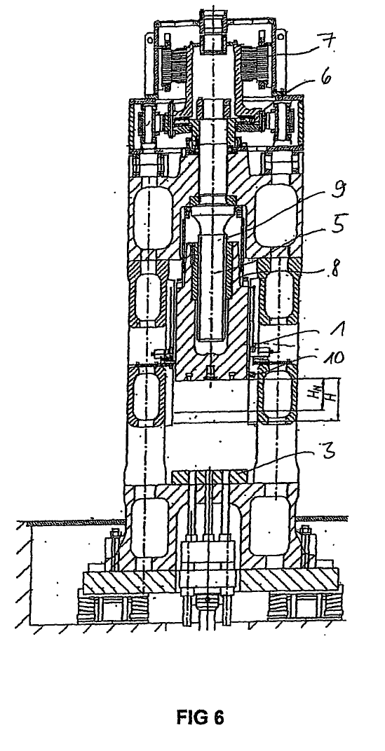

FIG. 6 an advantageous embodiment of a shaping device for the execution of the method in accordance with the invention.

### CARRYING OUT OF THE METHOD IN ACCORDANCE WITH THE INVENTION

Parts and sizes corresponding to each other are put the same reference signs into the FIG. 1 to 6.

The method of shaping is greatly simplified in FIG. 1a and FIG. 1b represented in accordance with the invention. FIG. 1a and FIG. 1b show a simple shaping device to the illustration with a striking tool, particularly a pestle 1, drive device 2 and a support 3 on which a workpiece 4 is disposed. The position of the pestle (not represented here, cf. FIG. 6) is determined with a position determiner. The pestle 1 is accelerated by a drive facility from an initial position H₀ₐ, H_{0b}, H_{0c}, H_{0d}(H₀ₐ=H_{0d}>H_{0b}>H_{0c}) (FIG. 1a). The initial velocities of the pestle, c₀ₐ, v_{0b}, v_{0c}, v_{0d} are 0 m/s, in all accompanying initial positions H₀ₐ, H_{0b}, H_{0c}, H_{0d}. The pestle 1 moves downwardly upon the support 3. When the pestle 1 has impacted the workpiece 4, it has reached an impact velocity V_{Aa}, V_{Ab}, V_{Ac}, V_{Ad} (FIG. 1b).

The initial position H₀ₐ, H_{0b}, H_{0c}, H_{0d} of the pestle 1 can be adjusted arbitrarily. Therefore, by way of example, two differently sized (e.g. heights) workpieces could also be processed with the same impact velocity V_{A}, which results from the same working stroke ΔH or by accelerating H₀ₐ, H_{0b}, H_{0c}, H_{0d} from the different initial positions under the different impact velocities V_{Aa}, V_{Ab}, V_{Ac}, V_{Ad} are reached. The maximal working stroke ΔHₐ, is reached from the initial position H₀ₐ and achieved is the maximum shaping energy at a continuous acceleration to a maximum impact velocity V_{Aa}. Arbitrarily lower initial positions, H_{0c}, H_{0d} can be set. The lower the chosen initial position the lower the at maximal attainable impact velocity (V_{Ab}>V_{Ac}) with continuous acceleration.

It is also possible with the method according to the invention to first accelerate the pestle 1 in direction of the workpiece 4 from an initial position H_{0d}, and after a pre-selected partial work stroke ΔH in a pre-selected height or position H_{d}, both for a subsequent position and for a braking position, to brake for a second pre-selected partial work stroke ΔH_{d2} so that an impact velocity vA_{d} is set with respect to the shaping energy that results, which is smaller than that which is possible to achieve from the initial position H_{0d}.

The pestle 1 can advantageously be constantly initially accelerated constantly, and brakingly decelerated with respectively different amounts of the acceleration. The method is not restricted, however, to this variant since initial acceleration and braking acceleration do not have to be constant.

In FIG. 1a, the partial working strokes ΔH_{d1} and ΔH_{d2} as well as the braking position H_{d} between initial accelerations and braking procedure only from the maximum initial position (H₀ₐ=H_{0d}) are represented. However, the pestle 1 can be at first accelerated also from all other initial positions (H_{0b}, H_{0c}=H_{0d}) and braked as of a predetermined position normally to the different position, H_{d} as depicted in FIG. 1a. When a lot of space must be available below the pestle if big or long workpieces must be put into the shaping device, a process with initial accelerations and braking procedure is of advantage in an embodiment. The pestle 1 for example is then driven from the maximum initial position H₀ₐ=H_{0d}, and after inserting the workpiece 4, the pestle 1 is first accelerated and then braked to the desired impact velocity v_{Ad}. If flat workpieces 4 are processed, the impact velocity V_{Aa}, V_{Ab}, V_{Ac} as a rule is simply raised by accelerating from the respectively necessary initial position H₀ₐ, H_{0b}, H_{0c}. The achieved speed and path of the pestle stroke, as well as the working stroke and the return stroke are determined by a control and regulation device that advantageously includes a microprocessor device in a frequency controlling device (here not depicted) that is brought down in the driving direction 2.

Thereby, at least the initial position H₀ₐ, H_{0b}, H_{0c}, H_{0d} and the desired impact velocities V_{Aa}, V_{Ab}, V_{Ac}, V_{Ad} are defaults. Furthermore the amount of the initial acceleration and the braking acceleration can be provided or be predefined or pre-set. The control and regulation facilities then calculate the stroke path ΔHₐ, ΔH_{b}, ΔH_{c}, with respect to ΔH_{d1} and ΔH_{d2}, about the height of the working stroke or partial working stroke, so that VAa, VAb, VAc VAd at the predefined values for the initial acceleration and the braking acceleration, if possible for reaching the desired impact velocity the shortest piston stroke time, altogether. The result can be a continuous stroke path with a continuous initial acceleration, or the control and regulation facilities determine an braking position H_{d}, for the pestle 1 for braking before striking.

The return piston stroke is indicated nominally by the arrow in FIG. 1a and 1b. After the impact on the workpiece 4 the pestle 1 is drawn back by use of a drive device 2 and returned to the initial position again, H₀ₐ, H_{0b}, H_{0c}, H_{0d}, or returned to an arbitrary other stopping position. At first the pestle 1 is accelerated and also braked by the control and regulation unit to a certain position H_{d} so that the speed approaches 0 m/s at the stop position. The position H_{d} as of which the pestle 1 is braked is depending on the desired stop position and perhaps also of the recoil of the pestle 1.

FIG. 2 shows theoretical speed-time processes with a constant initial acceleration from different initial positions H₀ₐ, H_{0b}, H_{0c}. The pestle is accelerated at constant initial acceleration from the initial position H₀ₐ, H_{0b}, H_{0c} to the maximum impact velocity V_{Aa}, V_{Ab}, V_{Ac} for a maximum shaping energy(100%). This maximum impact velocity V_{Aa}, V_{Ab}, V_{Ac} is marked in the diagram by V_{E100%} (H₀ₐ), V_{E100%} (H_{0b}), V_{E100%} (H_{0c}). The time duration to the maximum impact velocity V_{E100%} is reached, corresponds to the total duration of time of the working stroke of t_{GeS} from the respective initial position H₀ₐ, H_{0b}, H_{0c} in which to is always the same 0 s. From the diagram it is seen that from different initial starting positions H₀ₐ, H_{0b}, H_{0c} different high maximum impact velocities V_{E100%} (H₀ₐ), V_{E100%} (H_{0b}), V_{E100%} (H_{0c}) can be achieved, and indeed, the higher the initial position, the higher the impact velocity. The total time of the working stroke t_{Ges} prolongs itself with an increasing initial position H₀ₐ, H_{0b}, H_{0c}.

FIG. 3 shows initial acceleration theoretical speed-time processes at constant initial acceleration and connected constant braking for a constant impact velocity. Therefore, the same initial positions H₀ₐ, H_{0b}, H_{0c} such as in FIG. 2 achieve a constant impact velocity V_{A}, as in the case of FIG. 2 from which for example only 10% of the maximum shaping energy results. Therefore V_{E10}%, (H₀ₐ, H_{0b}, H_{0c}). The total time of the working stroke t can to every initial position about the dynamic equations at known constant initial acceleration and braking acceleration, known impact velocity and known initial position, and determine the working stroke time tⱼ or the stopping position to which the braking procedure must be carried out. The result of such an idealized velocity-time process is represented in FIG. 3. The maximum speeds vₘₐₓ (H₀ₐ), vₘₐₓ (H_{0b}), vₘₐₓ (H_{0c}), are reached after the working stroke times t₁, (H₀ₐ), t₁ (H_{0b}), t₁ (H_{0c}). The pestle is braked with the braking acceleration, and after the duration of the working stroke t_{Ges} (H₀ₐ), t_{Ges} (H_{0b}), t_{Ges} (H_{0c}), strikes the workpiece with the velocity V_{E10%}. From FIG. 3 it is seen that the higher the initial potion H₀ₐ, H_{0b}, H_{0c} is chosen, the longer is the duration of the working stroke t_{Ges} until the pre-selected impact velocity V_{E10%} is reached. Furthermore also the working stroke time t₁, (H₀ₐ), t₁ (H_{0b}), t₁ (H_{0c}) prolongs itself with an increased initial position, H₀ₐ, H_{0b}, H_{0c} until the braking procedure is started and the maximum speed of the pestle increases to vₘₐₓ (H₀ₐ), vₘₐₓ (H_{0b}), vₘₐₓ (H_{0c}).

The method in accordance with the invention made possible to produce different impact velocities from a constant initial position depending on desired results. FIG. 4 depicts three theoretical velocity-time paths are represented for reaching respectively different impact velocities from a constant initial position. The initial position corresponds to the maximum initial position H₀ₐ. In order to achieve the maximum shaping energy that corresponds to the maximum striking velocity V_{E100%} the pestle is constantly accelerated from the initial position H₀ₐ until it impacts the workpiece. The duration of this working stroke is marked in the diagram by t_{GeS} (100%). If merely an impact velocity V_{E50%} which corresponds to 50% of the maximum shaping energy shall be reached from the same initial position H₀ₐ, then the pestle is accelerated on Vₘₐₓ (50%) and as from a pre-selected position with respect to time is braked to the predefined impact velocity V_{E50%}. From the diagram it is depicted that this process lasts longer (t_{Ges} (50%)), from the acceleration on 100% of the shaping energy. The third curve also shows running into an impact velocity v_{E10%}, which corresponds to nominally 10% of the maximum shaping energy, also from the initial position H₀ₐ. In this case, the maximum speed vₘₐₓ (10%) is lesser than when producing the 50% shaping energy the total duration of the working stroke t_{Ges} (10%) again is longer. The connection between shaping energy E and speed V can ideally be given as E=½ mV². The velocity V is therefore proportional to the root of E.

FIG. 5 shows three real, measured speed time courses of the method in accordance with the invention which are comparable with the theoretical speed time courses represented in FIG. 4. The working stroke with respect to the initial position can be accepted by all curves A, B, and C as equal in size. For the shaping processes however different impact velocities were chosen with respect to different shaping energies, which are marked by 100%, 50% and 10% and assigned to the curves A, B, C, respectively. Moreover, the velocity-time paths respectively for the impact energy α, β, γ is overlaid for the velocity-time paths for the impacts of the pestle upon the workpiece.

The curve A (100%) shows the velocity-time path for an acceleration on the maximum speed for reaching the maximum shaping energy. The pestle is accelerated from the initial potions over the curve section K1, until it achieves the maximal possible striking velocity V_{E100%} in curve section K2. The curve section K3 depicts braking the pestle by the energy loss at the impact. A part of the energy is brought captured in the shaping process. The remaining energy is at least partly converted into a recoil of the pestle (K4). The balance of the velocity in the curve A (100%) can be explained by this recoil.

The pestle then is by means of the drive engine, as a rule, this one is driven controlledly in the direction of the stop position only after the impact and recoil switched on again or reconnected. At first, the pestle is accelerated up to a pre-selected position, as depicted in the curve section K5. When achieving the pre-selected position, the pestle is braked by means of the engine. The curve section K6 describes this situation or the necessary time by which it is represented in this and in the following curves and the maximum speed reached at that time. After achieving the pre-selected position, the pestle is braked by the drive engine until it reaches a very low velocity (K7). If the pestle has arrived at the pre-selected stop position, a mechanical brake grips the pestle as depicted in curve section 8. The pestle is braked to exactly 0 m/s and held in the stop position. The amount of the braking acceleration is changed by gripping the mechanical brake, which appears to be a small deflection in curve K8.

The impact strength a at which the pestle hits the workpiece is exactly carried out at the time. In the representation this can be seen to this that the maximum of α lies with a time shortly after reaching the desired impact velocity. This also applies to the impact strengths β and γ in the wider curves.

The curve B (50%) shows the velocity-time path for an acceleration on a velocity for reaching 50% of the maximum shaping energy at constant working stroke. This means that the pestle is first accelerated (K1) until a pre-selected position with a pre-selected maximum velocity vₘₐₓ is achieved (K9) and then followed by braking to the desired impact velocity V_{E50%} (K2). The reduction of the velocity during the braking process is depicted in curve section K10. In the curve section K2 the desired impact velocity V_{E50%} is then reached in turn. The further course of the curve B (50%) corresponds to the course of the curve A (100%). The pestle is braked (K3) and rebounds by the impact (K4). Then the drive engine grips and controls the pestle by accelerating (K5, K6) and braking (K7) into the stop position in which the mechanical brake stops the pestle (K8).

The curve C (10%) shows the velocity-time path for an acceleration on a velocity for reaching 10% of the maximum shaping energy at also a constant working stroke. The path of the curve is comparable with that of B (50%). The desired impact velocity V_{E10%} is, however, lower so that at first on a lower maximum velocity vmax than at B (50%) (K1, K9) is accelerated and must be braked over a longer time period (K10). The total time of the working stroke is insignificantly longer through this in comparison with B (50%).

A shaping device according to the invention represented is in FIG. 6 which is particularly suitable for the execution of the method in accordance with the invention. The pestle 1 is driven over a spindle 5. The spindle 5 disposes a pestle nut 8 fastened to the pestle 1 of a steep common thread 9 in this for it runs. The spindle 5 is coupled with a flywheel 6 of a drive engine 7, as a rule one changeable asynchronous machine, direct speed more variably are driven in its direction of rotation. The flywheel 6 is set into rotation and therewith the coupled spindle 5 by use of the drive motor. The angular velocity of flywheel 6 and spindle 5 is adjusted by the speed of the drive motor 7. A frequency converter unit with a microprocessor is provided for control and regulation of the speed (not represented here). The rotation of the spindle 5 is transferred to the pestle 1 over the spindle nut 8 and this moved by it toward the support 3 to or from this away. The speed of the drive engine 7 is a measure for the velocity of the pestle 1.

A workpiece can be found (not represented here) on the support 3 that the pestle hits with a pre-selected impact velocity. Shortly before the impact, the drive engine 7 is turned off so that the control and regulation facilities are protected from damage or impairment by peak voltage and peak currents which can be made at the impact. After the impact or recoil of the pestle 1 the drive engine 7 is switched on again and the pestle 1 is raised back into its stop position.

The position of the pestle 1 gets measured by an incremental, contactless position determiner 10, preferably by a magnetic one. The measurements can be transferred to the frequency converter unit and to external control and regulation facilities. The measured values are used by the frequency converter unit, for example, to communicate the rotational speed with respect to the velocities of the pestle, which is useful for an optimal shaping process of to reach the pre-selected final position of the pestle.

The Abstract is provided to comply with 37 C.F.R. § 1.72(b) requiring an abstract that will allow the reader to quickly ascertain the nature and gist of the technical disclosure. It is submitted with the understanding that it will not be used to interpret or limit the scope or meaning of the claims.

All publications, patents, and patent documents are incorporated by reference herein, as though individually incorporated by reference. The invention has been described with reference to various specific and preferred embodiments and techniques. However, it should be understood that many variations and modifications may be made while remaining within the spirit and scope of the invention.

Reference List

1 pestle
2 drive facilities
3 support
4 workpiece
5 spindle
6 flywheel
7 drive engine
8 spindle nut
9 threads
10 position givers
H₀ₐ, H_{0b}, H_{0c}, H_{0d} initial position
ΔHₐ, ΔH_{b}, ΔH_{c}, working stroke
H_{d} stop position
ΔH_{d1}, ΔHd2_{b} partial working stroke
V₀, V₀ₐ, V_{0b}, V_{0c} starting speed
V_{A}, V_{Aa}, V_{Ab}, V_{Ac} impact velocity
V_{E100}%, V_{E50}%, V_{E10}% impact velocity at 100%, 50%, 10% shaping energy
vₘₐₓ, V_{maxd} maximum velocity
t₀, t₁, t_{Ges} working stroke time
α, β, γ impact strength
K1 to K10 curve sections

1. A method for shaping at least one workpiece (4) comprising:
striking a workpiece (4) on a support (3) with a striking tool (1) with a striking movement from a predefined initial position (H₀ₐ, H_{0b}, H_{0c}) and pre-selected impact velocity (V_{Aa}, V_{Ab}, V_{Ac}, V_{Ad}), and
wherein the speed of the striking tool (1) during the striking movement, is controlled or regulated dependent upon the position of the striking tool (1) and dependent upon the pre-selected impact velocity (v_{Aa}, v_{Ab}, v_{Ac}, v_{Ad}).

2. The method according to claim 1, wherein at least one position of the striking tool (1) is measured or determined, and wherein with at least one previous position of the striking tool (1) and a pre-selected impact velocity (v_{Aa}, v_{Ab}, v_{Ac}, v_{Ad}) of the striking tool (1) is calculated during the striking movement.

3. The method according to claim 2, wherein the position value of the striking tool (1) is communicated to a control and regulation device for control or regulation of the striking tool.

4. The method according to claim 2, wherein at which the initial position (H₀ₐ, H_{0b}, H_{0c}) of the striking tool (1) and/or the position thereof after a return stroke movement thereof is measured or determined.

5. The method according to claim 2, wherein the position of the striking tool (1) is measured or determined by the impact after the deformation of the workpiece (4).

6. The method according to claim 1, wherein at the striking tool (1) is accelerated to a pre-selected impact velocity (v_{Aa}, v_{Ab}, v_{Ac}) from the initial position (H₀ₐ, H_{0b}, H_{0c}).

7. The method according to claim 6, wherein the initial position (H_{0b}, H_{0c}) is adjusted lower than a maximum initial position (H₀ₐ) for reaching an impact velocity (v_{Ab}, v_{AC}) that is lower than a maximum impact velocity (V_{Aa}).

8. The method according to claim 1, wherein the striking tool (1) accelerates from the initial position (H_{0d}) and is braked when it reaches a predetermined position (H_{d}) between the initial position (H_{0d}) and the workpiece (4) in order to achieve a pre-selected impact velocity (V_{Ad}).

9. The method according to claim 1, wherein the velocity of the striking tool (1) is controlled or regulated during the striking movement so that from an arbitrary initial position (H₀ₐ, H_{0b}, H_{0c}, H_{0d}), the shortest possible working stroke (t_{Ges}) is achieved.

10. The method according to claim 1, wherein the control and regulation of the velocity of the striking tool (1) is carried out with the control and regulation facilities for the striking tool, which steers and regulates a variable-velocity drive motor (7) in a drive device (2).

11. The method according to claim 10, wherein a frequency converter unit is used as a control and regulation facility, which controls and regulates the rotational speed and rotational direction of the drive motor (7).

12. The method according to claim 11, wherein a frequency converter is controlled with the help of a microprocessor, which controls the rotational velocity of the drive motor (7) during the impact stroke, dependent upon a predefined impact velocity (V_{Aa}, V_{Ab}, V_{Ac}, V_{Ad}) and a pre-selected initial position (H₀ₐ, H_{0b}, H_{0c}) and/or by a position measuring facility or by a pre-selected position.

13. The method according to claim 1, wherein after the impact, the striking tool (1) is returned to a pre-selected stop position by a return stroke.

14. The method according to claim 13, wherein the return stroke to the stop position is accomplished by a at which the return stroke movement is carried out into the stop position at a reversed direction of rotation of the drive engine (7).

15. The method according to claim 13, wherein the velocity of the striking tool (1) during the return stroke to the stop position is controlled and regulated by the position of the striking tool (1).

16. The method according to claim 15, wherein the control and regulation of the velocity of the striking tool (1) is carried out with the frequency converter unit, which determines the rotational path during return stroke of the moving piston stroke by dependence of the pre-selected stop position and/or one by the position measuring facility to determine the position thereof.

17. The method according to claim 13, wherein the stop position of the return stoke initial position (H₀ₐ, H_{0b}, H_{0c}) of the striking tool (1) is chosen for the working stroke (ΔHₐ, ΔH_{b}, ΔH_{c}).

18. The method according to claim 13, wherein the stop position of the return stoke initial is dependent upon the workpiece (4) to be worked on and/or by the desired impact velocity (v_{Aa}, v_{Ab}, v_{Ac}, v_{Ad}) depending upon the subsequent striking movement.

19. The method according to claim 13, where the return stroke of the striking tool (1) is accelerated away from the workpiece (4) or support (3) into the stop position, and when achieving a pre-selectedposition (H_{d}) between the workpiece (4) or the support (3) on the one hand, and the stop position on the one hand, is braked by the drive motor (7).

20. The method according to claim 13, wherein the striking tool (1) is braked completely by mechanical braking facilities when reaching the stop position.

21. The method according to claim 1, wherein with the striking tool (1) is traveled to the stop position, the workpiece (4) is removed from the shaping device (1).

22. The method according to claim 1, wherein the striking tool (1) is accelerated with a predefined constant initial acceleration.

23. The method according to claim 1, wherein the striking tool (1) is braked when braking with a pre-selected constant braking acceleration.

24. The method according to claim 10, wherein immediately before the impact of the striking tool (1) on the workpiece (4), the drive engine (7) becomes switched and/or disengaged within the drive device (2).

25. The method according to claim 1, wherein during braking the striking tool (1) by the drive engine (7), the drive engine (7) is operated as a generator and during energy economized by the generator is returned to a power supply system.

26. The method according to claim 1, wherein the position of the striking tool (1) is determined by at least one position determiner, selected from a visual or magnetic or inductive or incremental position determiner, and further selected from a contact-less position determiner.

27. The method according to claim 1, wherein the shaping device is used, which is a spindle press, and wherein a drive motor (7) in the drive implementation (2) of the spindle press works and is directly driven by a flywheel (6), and the sets a coupled spindle (5) into rotation therewith.

28. A shaping device, comprising:
a) at least one support (3) for a workpiece;
b) at least one striking tool (1);
c) at least one drive implementation (2) for moving the striking tool (1) relative to the support (3); and
d) at least one position-measuring device for determining the position of the striking tool (1);
wherein for the shaping of the workpiece (4) an initial position (H₀ₐ, H_{0b}, H_{0c}) of the striking tool (1) is settable of is pre-set, and wherein a control and regulation device is provided that controls and regulates the velocity of the striking tool (1) during a striking movement that is dependent upon the position thereof, such that pre-selected or a striking velocity (v_{Aa}, v_{Ab}, v_{Ac}, v_{Ad}) is achieved upon the workpiece (4).

29. The shaping device according to claim 28, wherein the drive implementation (2) is an asynchronous machine.

30. The shaping device according to claim 28, wherein the drive implementation (2) includes a flywheel (6) coupled to a spindle (5), and wherein the drive implementation (2) is driven by a drive engine (7).
